(19) United States
(12) Patent Application Publication
(10) Pub. No.: US 2006/0214883 A1
(43) Pub. Date: Sep. 28, 2006

(54) Plasma display panel driving apparatus, signal processing method for plasma display panel and image display apparatus for plasma display panel

(76) Inventors: Dae Jin Myoung, Goyang-si (KR); Seong Hak Moon, Seoul (KR)

Correspondence Address: FLESHNER & KIM, LLP, P.O. BOX 221200, CHANTILLY, VA, 20153, US

(21) Appl. No.: 11/386,091

(22) Filed: Mar. 22, 2006

(30) Foreign Application Priority Data
Mar. 22, 2005 (KR) 10-2005-0023484

(51) Int. Cl. G09G 3/28

(52) U.S. Cl. 345/60

(57) ABSTRACT

A plasma display panel (PDP) driving apparatus, a signal processing method for PDP and an image display apparatus for PDP are disclosed, wherein a load effect caused by a shape of an image displayed on the PDP in displaying image corresponding to inputted image data on the PDP to thereby enable to display an even picture quality regardless of the shape of the image. In order to accomplish this object, the PDP driving apparatus reflects a ratio between a horizontal component load and a vertical component load and an entire load as well to thereby compensate the number of sustain pulses of subfield mapping data.

### CROSS-REFERENCE TO RELATED APPLICATIONS

This application claims priority under 35 U.S.C. § 119 to Korean Patent Application No.10-2005-0023484, filed on Mar. 22, 2005, the entirety of which is hereby incorporated by reference.

### BACKGROUND

This description relates to a plasma display panel (PDP) driving apparatus, a signal processing method for PDP and an image display apparatus for PDP. More particularly, the present invention relates to a plasma display panel driving apparatus, a signal processing method for PDP and an image display apparatus for PDP configured to consider an entire load of each frame and a ratio between a vertical component load and a horizontal component load into account, thereby enabling to compensate a load effect and to display a uniform picture quality regardless of shapes of each image.

As is well known in the art, a Plasma Display Panel (PDP) is a flat plate display having a plurality of discharge cells for displaying characters or images using plasma generated by gas discharge where pixels ranging from hundreds of thousands to more than millions are arranged in the form of a matrix format from which visible rays are selectively emitted to restore image data inputted in electric signals.

FIG. 1 is a block diagram illustrating a conventional plasma display panel driving apparatus, FIG. 2 is a graph illustrating an inverse gamma correction, and FIG. 3 illustrates one frame period for a PDP.

Now, referring to FIGS. 1 to 3, description is made to the conventional plasma display panel.

An inverse gamma corrector 101 performs inverse gamma correction on luminance of an input video signal to generate image data. In detail, since a cathode ray tube has a non-linear luminance characteristic, and the PDP has a linear luminance characteristic, abnormal noise is generated from expression of grayscales in low gray scale region. In order to solve the generation of noise, the inverse gamma corrector 101 inverse-gamma corrects the image data.

Referring to FIG. 2, a ‘target luminance (brightness)’ indicates the ideal result to be obtained by the inverse gamma correction, a ‘real luminance’ denotes a measured luminance value represented as a result of the inverse gamma correction and a ‘luminance’ represents a luminance value not performed by the inverse gamma correction. The PDP luminance is reflected by a linear luminance characteristic of PDP. The PDP indicates a real luminance characteristic near to the target luminance as the PDP luminance is inverse-gamma corrected. The target luminance is represented as one of the luminance values, each of which has the gray level of 61 steps (0 through 60). On the contrary, the real luminance is represented as eight luminance values, each of which has one of the gray levels of 61 steps (0 through 60). Furthermore, the real luminance is hardly changed at value thereof at a low gray level. Accordingly, when the inverse gamma correction process is performed in the PDP, a sufficient gray level representation cannot be obtained in a dark area, and so there is a problem that the contour noise appears in which the images are lumped together.

Image data inverse-gamma corrected by the inverse gamma corrector 101 is adjusted to have a predetermined gain by a gain adjuster 103.

A half tone corrector 105 performs various procedures for expressing a large number of gray scales via a small number of real gray scales in the PDP. To be more specific, in order to enhance the insufficient gray level representation capability of the PDP, the half tone correction such as dithering relative to images inputted from the gain adjuster 103 or error diffusion is performed.

First of all, in the error diffusion method, fraction generated when the gray level value of the corresponding pixel is quantized, that is, an error has influence on the adjacent pixels so that the correction to an error to be discarded is spatially solved. An error diffusion coefficient to the adjacent pixel is set constantly, and so such error diffusion method is repeated to each line and each frame. Accordingly, there is a problem that the same error diffusion pattern is formed on the entire screen due to the constant error diffusion coefficient.

The dithering method is the method for judging whether a carry is generated or not by comparing the gray level value of each pixel with a specific threshold of a dither mask.

That is, the dithering method is the method for enhancing the insufficient gray level capability by turning on the pixel in which the carry is generated and turning off the pixel in which the carry is not generated. Such dithering mask uses a plurality of dither masks on which constant patterns are formed. Accordingly, there is a problem that the patterns of the dither mask are displayed on a screen due to repeated use of the dither mask.

In order to overcome the above problem of the error diffusion method and the dithering method and enhance the gray level capability, the error diffusion method is preferably used together with the dithering method.

A subfield mapping unit 107 converts the image data half-tone corrected by the half-tone corrector 105 to a predetermined subfield mapping data. In order to embody the gray scale of image data, the PDP divides one frame into several subfields each having a different illumination frequency, thus generating subfield mapping data spatially arranged relating to the time. To be more specific, the conventional PDP displays an image by dividing a frame period into a plurality of subfields which are different in the number of discharges. The received image data is mapped in a field memory (not shown) for the plurality of divided subfields. The image data mapped in each field memory is called a subfield mapping data.

It is assumed in FIG. 3 for ease of description that one field has several subfields (SF1-SF8). In addition, each subfield (SF1-SF8) is divided into address periods (a) for selecting discharge cells and sustain periods (b) for embodying gray scales in response to discharge frequency. At this time, the address period (a) determines from which cell the light is to be illuminated relative to a frame to be currently displayed, and the sustain period (b) adjusts the number of sustain in response to desired brightness.

Referring again to FIG. 1, configuration will be described. The subfield mapping data outputted from the subfield mapping unit 107 are respectively inputted into a data arrangement unit 109 and a load compensation unit 111. The data arrangement unit 109 arranges data per subfield and transmits it to a driving part 115 for driving the PDP. The load compensation unit 111 calculates an entire load of a current frame based on the subfield mapping data to determine a sustain compensation coefficient to be compensated, and transmits information on the sustain compensation coefficient to a timing controller 113. The timing controller 113 adjusts a length of the sustain period (b) based on the sustain compensation coefficient.

At this time, the load defines a ratio of cells selected for emitting light against an entire cell constituting an entire screen of the PDP. The load increases as the number of cells selected for emitting light increases. The brightness (luminance) of the PDP is adjusted by the number of sustain pulses, and even if the number of sustain pulses is the same, the brightness differs according to the load.

The timing controller 113 generates timing control signals for controlling a driving timing relative to each driver of a driving part 115. In other words, the timing controller 113 generates a variety of switching control signals for generating waves for driving the PDP and supplies the signals to the driving part 115.

The driving part 115 includes a predetermined driver containing an address driving unit, a scan driving unit and a sustain driving unit, and drives the PDP using subfield data of the data arrangement unit 109 and the timing control signal inputted from the timing controller 115.

FIG. 4 is a graph illustrating luminance changes of the PDP in response to the load, and relative to the number of a predetermined sustain, where part indicated in a solid line denotes luminance relative to load, and part indicated in a dotted line represents a target luminance of a relevant load.

Referring to FIG. 4, it can be seen that the luminance decreases as the load increases although the number of sustain pulses is the same. This is called ‘Load Effect’. In other words, the PDP should always show a luminance of B relative to the same number of sustain pulses regardless of the load. If a load is L1, luminance loss as much as E1 occurs, and if a load is L2, luminance loss as much as E2 occurs. After all, much more power is needed for achieve the same luminance as the load increases.

Luminance level desired by a particular subfield is defined by the number of sustain pulses corresponding thereto when the PDP is operated. However, as shown in FIG. 4, luminance according to the number of sustain pulses thus defined changes relative to the load, which is indicated in the form of distortion of gray scale.

FIG. 5 illustrates an example of degradation of picture quality according to the load effect. A period (c) of an input grayscale level of 32 should have a luminance higher than a period (d) of an input grayscale level of 31. However, there occurs degradation where the period (c) of the input grayscale level of 32 has luminance less than that of the period (d) of 31. In other words, discharge current increases as the load increases, and if the discharge current increases, a voltage drop is generated by resistant elements inherent in the panel and circuit, thereby resulting in occurrence of inversed luminance. This is one of the causes of degradation of picture quality where grayscales are distorted and uneven images are displayed.

To cope with this problem, a technique has been employed where a reference luminance at a particular number of sustain pulses is designated, and the number of sustain pulses is increased or decreased relative to the load to constantly maintain luminance of a screen across an entire load. In FIG. 4, a compensation method is such that the number of sustain pulses corresponding to loss is increased in order to compensate the luminance loss as much as E1 that is generated if the load is L1, and if the load is L2, the number of sustain pulses corresponding to the luminance loss as much as E2 is increased.

However there is a problem in that luminance difference relative to the load cannot be accurately compensated because calculation is made roughly on the basis that the load is simply turned on across the entire screen.

FIG. 6 shows exemplary illustrations of degradation of picture quality that differently occurs relative to horizontal/vertical components. Referring to FIG. 6, each screen of (1), (2) and (3) shows a predetermined period having a grayscale of 32. Although the respective periods of (2) and (3) show the same area, an actual luminance is indicated less in (2). In other words, if a luminance change is measured with respect to the load effect, reduction in luminance is much evident in crosswise discharge compared with that of lengthwise discharge even in the same area. Consequently, a compensation circuit that compensates in view of an entire load according to the conventional method cannot completely improve the degradation of a picture quality.

### SUMMARY

One object of the invention is to provide a plasma display panel (PDP) driving apparatus and a signal processing method for PDP configured to consider into account the shapes of periods in which the PDP is turned on, thereby enabling to accurately compensate a load effect of the PDP.

Another object is to provide an image display apparatus for PDP configured to display an image compensated of its load effect that can be generated in the PDP against an inputted image data.

In accordance with the object of the present invention, a signal processing method for PDP comprising: calculating a sustain compensation coefficient based on an entire load of subfield mapping data having a predetermined number of sustain pulses; increasing and decreasing the sustain compensation coefficient thus calculated relative to a ratio of horizontal component load and vertical componentload; and adding the increased and decreased compensation coefficient to the number of the sustain to compensate the subfield mapping data.

The step of increasing and decreasing the sustain compensation coefficient thus calculated is performed by increasing and decreasing the sustain compensation coefficient calculated on the entire load in proportion to (the horizontal component load/vertical component load).

The load of the horizontal component can be obtained by the following Equation if the vertical component of load is the number (Nₗᵢₙₑ₋ₒₙ) of lines in which turned-on cells exceed more than 10% in the lines of the PDP, where H denotes a load of the horizontal component, Nₜₒₜ₋ₒₙ denotes the number of cells that are turned on in each subfield, Nₗᵢₙₑ₋ₒₙ denotes the number of lines in which turned-on cells exceed more than 10% in the lines.

$$H = \frac{{N}_{tot - on}}{{N}_{line - on}}$$

A PDP driving apparatus according to another embodiment of the present invention comprises: a subfield mapping unit, a signal processing unit, a timing controller and a driving unit, wherein the subfield mapping unit generates a subfield mapping data having a predetermined number of sustain pulses corresponding to inputted image data, the signal processing unit adds to the number of sustain pulses a sustain compensation coefficient calculated on the entire load of the subfield mapping data to compensate the subfield mapping data, where the calculated sustain compensation coefficient is increased and decreased in response to the ratio of the horizontal component and vertical component of the load, the timing controller generates predetermined timing control signals based on the number of sustain pulses of the compensated subfield mapping data, and the driving unit drives the PDP based on timing control signal of the timing controller.

The signal processing unit may comprise: a vertical component measuring unit measuring the load of the vertical component and outputs it to the load compensation unit; and a horizontal component measuring unit measuring the load of the horizontal component and outputs it to the load compensation unit.

An image display apparatus according to yet another embodiment of the present invention comprises a PDP driving apparatus for displaying an image corresponding to an image data on the PDP.

### BRIEF DESCRIPTION OF THE DRAWINGS

FIG. 1 is a block diagram illustrating a PDP driving apparatus according to the prior art.

FIG. 2 is a graph explaining an inverse gamma correction.

FIG. 3 is a schematic drawing illustrating one frame period for a PDP.

FIG. 4 is a graph illustrating luminance changes of the PDP according to a load.

FIG. 5 is a schematic drawing illustrating one example of degradation of picture quality according to the load effect.

FIG. 6 is a schematic drawing illustrating one example of degradation of picture quality differently occurring relative to the horizontal/vertical components.

FIG. 7 is a block diagram illustrating a PDP driving apparatus according to the present invention.

FIG. 8 is an example of a screen compensated regardless of the vertical/horizontal components according to the present invention.

FIG. 9 is one embodiment of a signal processing method according to the present invention.

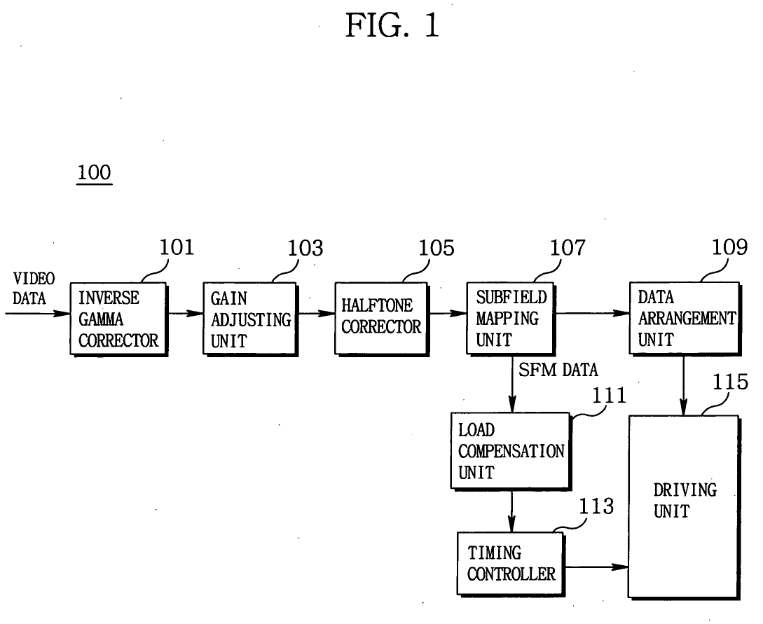

### DETAILED DESCRIPTION

Hereinafter, the present invention will be explained in detail with reference to embodiments and accompanied drawings.

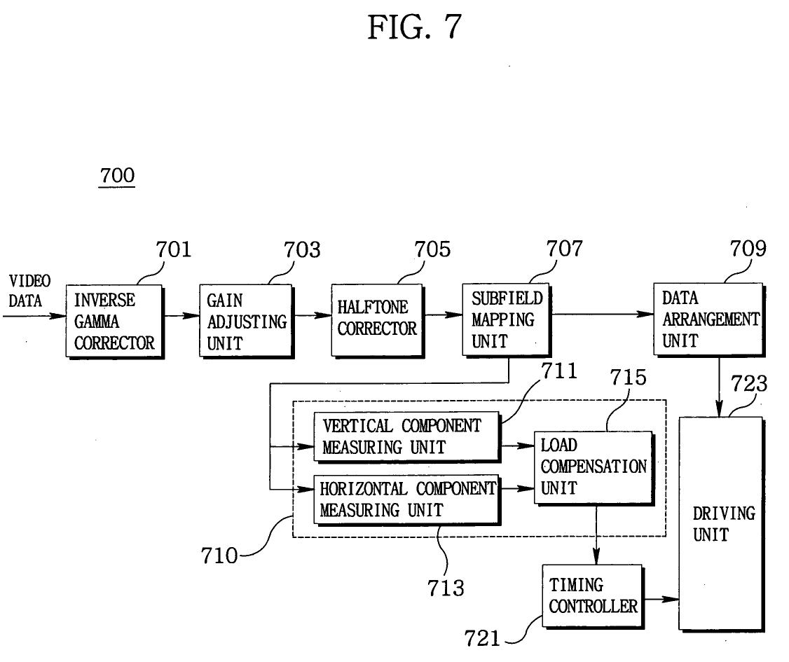

First, referring to FIG. 7, a driving apparatus 700 of the present invention includes an inverse gamma corrector 701, a gain adjusting unit 703, a halftone corrector 705, a subfield mapping unit 707, a data arrangement unit 709, a signal processing unit 710, a timing controller 721 and a driving unit 723.

The driving apparatus 700 may include an image display apparatus receiving a predetermined image data and displaying an image corresponding thereto on a PDP. For this, the driving apparatus 700 converts the inputted image data to a predetermined driving signal and drives a PDP (not shown). The luminance of the PDP is adjusted by the number of sustain pulses, and even if the number of the sustain pulses is the same, the luminance thereof decreases as the load increases. The driving apparatus 700 performs a predetermined compensation relative to the image data in order to compensate the load effect in which the luminance thereof decreases as the load increases.

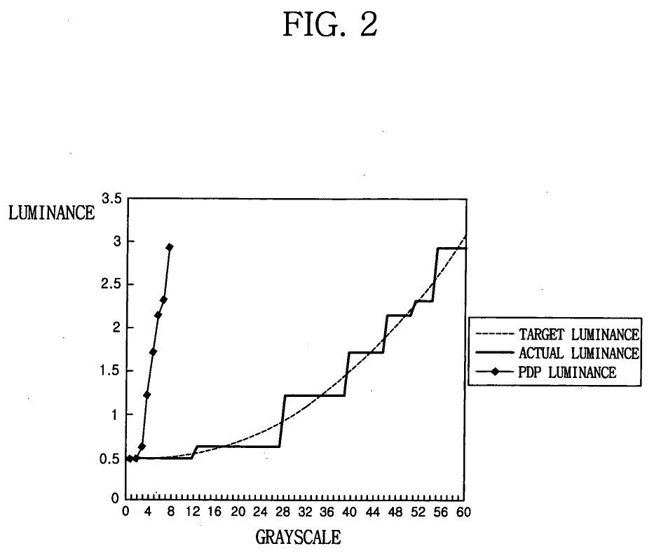

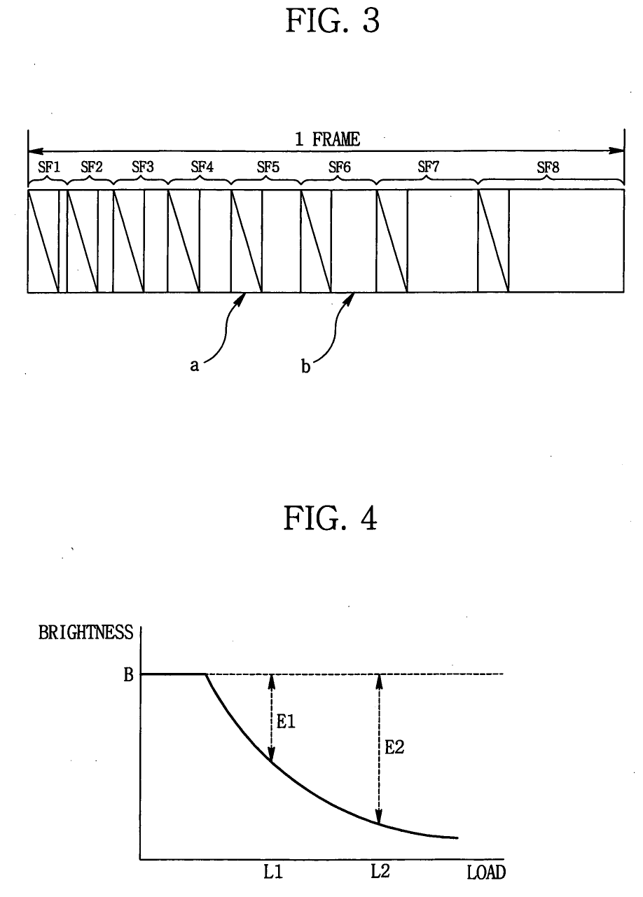

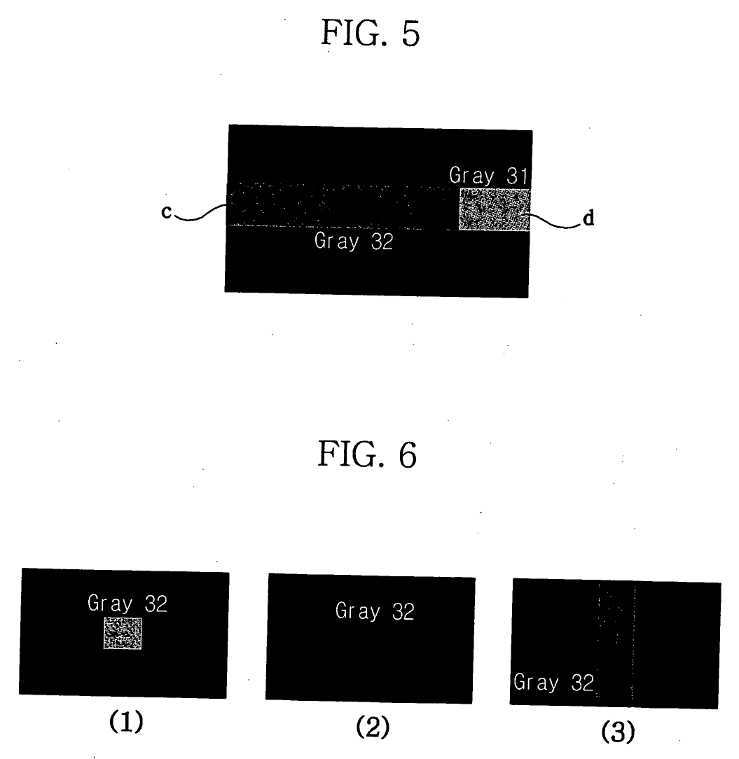

The inverse gamma corrector 701, the gain adjusting unit 703, the halftone corrector 705, the subfield mapping unit 707, the data arrangement unit 709, the timing controller 721 and a driving unit 723 illustrated in FIG. 7 correspond to the inverse gamma corrector 101, the gain adjusting unit 103, the halftone corrector 105, the subfield mapping unit 107, the data arrangement unit 109, the timing controller 113 and the driving unit 115 of FIG. 2, and may be explained likewise.

The inputted image data is converted to a subfield mapping data by the subfield mapping unit 707 via the inverse gamma corrector 701, the gain adjusting unit 703 and the halftone corrector 705.

The subfield mapping data outputted from the subfield mapping unit 707 is inputted into the data arrangement unit 709, and the data arrangement unit 709 arranges data per each subfield and transmits it to the driving unit 723. Furthermore, the subfield mapping data outputted from the subfield mapping unit 707 is inputted into the signal processing unit 710.

The signal processing unit 710 includes a vertical component measuring unit 711, a horizontal component measuring unit 713 and a load compensation unit 715, and compensates a predetermined load effect relative to the subfield mapping data received from the subfield mapping unit 707.

The vertical component measuring unit 711 measures a vertical component load relative to the subfield mapping data outputted from the subfield mapping unit 707. The vertical component measuring unit 711 outputs the measured load of the vertical component to the load compensation unit 715. At this time, the vertical component load denotes a vertical formation ratio of cells turned on at each subfield. The vertical component load may be obtained by the following Equation 1.
V=Nₗᵢₙₑ₋ₒₙ Equation 1

where, V denotes a the vertical component load, Nₗᵢₙₑ₋ₒₙ denotes the number of lines in which turned-on cells exceed more than 10% in the lines.

The horizontal component measuring unit 713 measures a horizontal component load relative to the subfield mapping data outputted from the subfield mapping unit 707. The horizontal component measuring unit 713 outputs the measured load of the horizontal component to the load compensation unit 715. The horizontal component denotes a horizontal formation ratio of cells turned on at each subfield. The horizontal component load may be obtained by the following Equation 2.

$$H = \frac{{N}_{tot - on}}{{N}_{line - on}} \qquad Equation 2$$

where, H represents a horizontal component load, Nₜₒₜ₋ₒₙ denotes the number of cells turned on at each subfield, and Nₗᵢₙₑ₋ₒₙ represents the number of lines in which the turned-on cells exceed more than 10% in the lines(scan line).

The load compensation unit 715 calculates a sustain compensation coefficient in consideration of the ratio of the horizontal component load and vertical component load and an entire load, based on the subfield mapping data, and adds the calculated sustain compensation coefficient to the number of sustain pulses to thereby compensate the load effect.

The load compensation unit 715 first calculates the entire load of the subfield mapping data, and determines the sustain compensation coefficient relative to the calculated entire load.

Furthermore, the load compensation unit 715 increases and decreases the sustain compensation coefficient calculated on the entire load, based on ratio between the horizontal component load measured by the horizontal component measuring unit 713 and the vertical component load measured by the vertical component measuring unit 711.

The load compensation unit 715 uses the sustain compensation coefficient increased and decreased relative to the ratio between the horizontal component load and the vertical component load to seek the number of compensated sustain pulses. The number of sustain pulses finally obtained by the load compensation unit 715 can be obtained by the following Equation 3.
The number of compensated sustain pulses=[a*(H/V)*N_sus]+the number of sustain pulses before compensation Equation 3

where H denotes a horizontal load component, V represents a vertical load component and N_sus defines a sustain compensation coefficient based on the entire load. Furthermore, ‘a’ which is a coefficient obtained by experiment may vary relative to characteristic of cell device of PDP, size and state of a driving power source, the number of cells in the PDP and the like.

With the assistance of the coefficient, the load compensation unit 715 can embody an accurate grayscale despite the load effect that is differently shown relative to the shapes of images displayed on a screen.

The load effect becomes more evident as the horizontal component load increases. In summary, the load compensation unit 715 is such that if the horizontal component load is larger than the vertical component load, compensation level can be made to increase, and the compensation level can be made to decrease if in the reverse case. However, it is preferred that increase and decrease of the sustain compensation coefficient relative to the ratio between the horizontal component load and the vertical component load be in inverse proportion to the ratio of the vertical component load relative to the horizontal component load.

For example, assuming that a sustain compensation coefficient by the entire load is ‘A’, if the horizontal component load in the entire load is larger than the vertical component load, the sustain compensation coefficient may be a value where ‘A’ is added by ‘a’, and in the reverse case, the sustain compensation coefficient may be a value where ‘A’ is subtracted by ‘β’. Operation of the signal processing unit 710 will be described in more detail in the following.

For this, the load compensation unit 715 may store in advance a changed value of luminance corresponding to the ratio of the vertical component load/the horizontal component load. Preferably, the changed value of luminance is based on a data measured in advance according to the characteristic of the PDP.

The timing controller 721 generates timing control signals for controlling a driving timing relative to each driver of the driving unit 723, based on the number of sustain pulses received from the load compensation unit 715.

The driving unit 723 includes an address driving unit, a scan driving unit and a sustain driving unit, and uses the subfield data of the data arrangement unit 709 and timing control signals inputted from the timing controller 721 to drive the PDP.

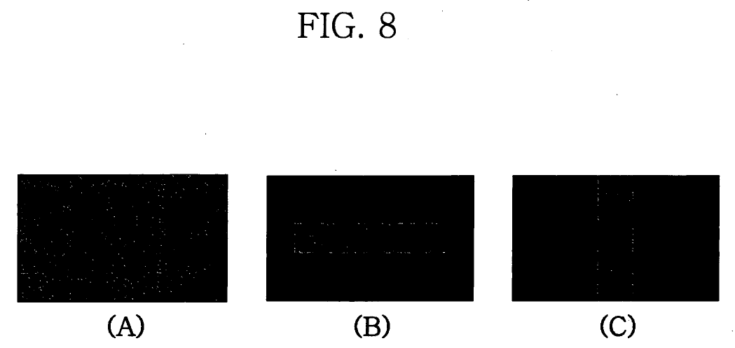

FIG. 8 illustrates 3 screens displayable by a PDP. Screen (A) displays an entire image indicative of grayscale of 32, screen (B) displays only an image part of a horizontal bar shape indicative of grayscale of 32, and screen (C) displays only an image part of a vertical bar shape indicative of grayscale of 32. It can be noted that the luminances of 3 screens of the PDP according to the present invention are the same regardless of the shapes being displayed.

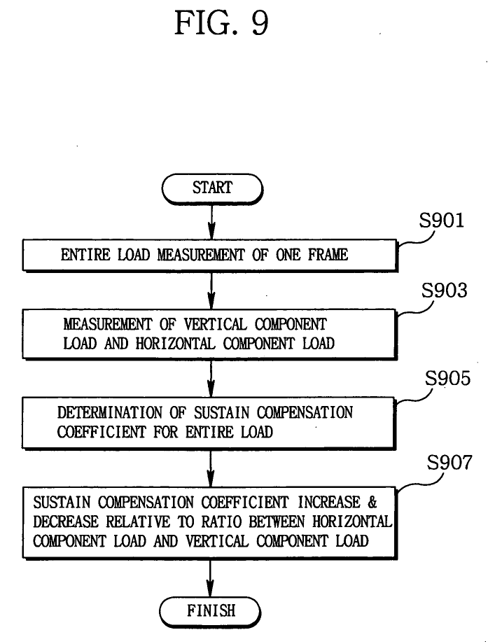

Hereinafter, operation of the signal processing unit 710 will be described in detail with reference with FIGS. 8 and 9.

The load compensation unit 715 measures an entire load of the subfield mapping data relative to inputted image data of one frame (S901).

The vertical component measuring unit 711 and the horizontal component measuring unit 713 respectively measure the vertical component load and the horizontal component load of the subfield mapping data inputted from the subfield mapping unit 707, and respectively output the measured vertical component load and the horizontal component load to the load compensation unit 715.

It should be noted that steps S901 and S903 do not have to be sequentially processed at all times or may be measured in parallel relative to embodiments. Otherwise, the vertical component load and the horizontal component load may be measured ahead of the entire load.

The load compensation unit 715 determines the sustain compensation coefficient relative to the entire load. For instance, if the entire load is 60%, compensation is made in a lump by +1 based on load of 50%, and compensation is given across the board by −1 based on load of 40% (S905).

The load compensation unit 715 increases and decreases the sustain compensation coefficient determined at S905, based on the ratio of the horizontal component load and the vertical component load inputted from the vertical component measuring unit 711 and the horizontal component measuring unit 713. For example, even if the compensation has been made by +1 at S905 because of the entire load of 60%, a value less than +1 should be compensated if the ratio of the vertical component load relative to the horizontal component load is equal to or larger than 1 (S907).

The timing controller 721 adjusts the length of the sustain period on the subfield by using the sustain compensation coefficient finally calculated and inputted from the load compensation unit 715. Accordingly, the luminance of the image displayed on the screen varies.

As explained in FIG. 8, luminance is all the same for the case (A) where the entire image has a grayscale of 32, the case (B) where an image of horizontal bar shape has a grayscale of 32, and the case (C) where an image of vertical bar shape has a grayscale of 32. In other words, the same luminance is shown for the same grayscale value regardless of the shape of the image.

As apparent from the foregoing, the same luminance is displayed relative to the same grayscale regardless of the shape of the image to be outputted from a PDP in the PDP driving apparatus according to the present invention. For this, the PDP driving apparatus according to the present invention compensates the number of sustain pulses by reflecting the entire load and the ratio of the horizontal component and the vertical component as well, such that degradation of picture quality caused by typical load effect of the PDP can be effectively improved to thereby enable to enhance the picture quality.

The present invention can be embodied by devices and systems. Furthermore, if the present invention is embodied by computer software, constituent parts of the present invention may be replaced by code segments necessary for implementation of the essential operation. The code segments or programs can be stored in a medium processible by a microprocessor, and can be transferred as computer data coupled with carrier wave via transmission media or communication networks.

The media processible by the microprocessor include what can transmit and store information, such as electronic circuits, semiconductor memory devices, ROMs, flash memories, EEPROMs, floppy discs, optical discs, hard discs, optical fibers, wireless networks and the like. Accordingly, computer data include data that can be transmitted via electrical network channels, optical fibers, electromagnetic fields, and wireless networks.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A signal processing method for PDP comprising: calculating a sustain compensation coefficient based on an entire load of subfield mapping data having a predetermined number of sustain pulses; adjusting the sustain compensation coefficient based on a ratio of a horizontal component and a vertical component of the load; and adding the adjusted sustain compensation coefficient to the predetermined number of sustain pulses to compensate the subfield mapping data.

2. The method of claim 1, wherein adjusting the sustain compensation coefficient includes;
increasing or decreasing the sustain compensation coefficient calculated on the entire load in proportion to a ratio of the horizontal load and the vertical load component.

3. The method as defined in claim 1, wherein the horizontal component load is calculated based on the following Equation;
$$H = \frac{{N}_{tot - on}}{{N}_{line - on}}$$
where H denotes the horizontal load component, Nₜₒₜ₋ₒₙ denotes a number of cells that are turned on in each subfield, and Nₗᵢₙₑ₋ₒₙ denotes a number of lines in which turned-on cells exceed more than a predetermined percentage in the lines of the PDP.

4. The method of claim 3, wherein the predetermined percentage is 10%.

5. A PDP driving apparatus comprising: a subfield mapping unit to generate a subfield mapping data having a predetermined number of sustain pulses corresponding to input image data; a signal processing unit to add to the predetermined number of sustain pulses a sustain compensation coefficient calculated based on an entire load of the subfield mapping data to compensate the subfield mapping data, the calculated sustain compensation coefficient adjusted based on a ratio of a horizontal component and a vertical component of the load; a timing controller to generate predetermined timing control signals based on the number of sustain pulses of the compensated subfield mapping data; and a driving unit to drive the PDP based on the timing control signals generated by the timing controller.

6. The apparatus of claim 5, wherein the signal processing unit increases and decreases the sustain compensation coefficient calculated on the entire load based on a ratio of the horizontal load component and the vertical load component.

7. The apparatus of claim 5, wherein the horizontal load component is calculated by the following Equation;
$$H = \frac{{N}_{tot - on}}{{N}_{line - on}}$$
where H denotes the horizontal load component, Nₜₒₜ₋ₒₙ denotes a number of cells that are turned on in each subfield, and Nₗᵢₙₑ₋ₒₙ denotes a number of lines in which turned-on cells exceed more than a predetermined percentage in the lines of the PDP.

8. The apparatus of claim 7, wherein the predetermined percentage is 10%.

9. The apparatus of claim 5, wherein the signal processing unit comprises: a vertical component measuring unit to measure a vertical load component for input into the load compensation unit; and a horizontal component measuring unit to measure the horizontal load component for input into the load compensation unit.

10. The apparatus of claim 5, wherein the subfield mapping unit, the signal processing unit and the timing controller are formed by one chip.

11. An image display apparatus for PDP comprising a driving apparatus as recited in claim 5.

12. A PDP driving method comprising: mapping a subfield having a predetermined number of sustain fields onto a frame expressing an image information; and adjusting a predetermined number of sustain pulses corresponding to the subfield mapping data based on a ratio of a horizontal component and a vertical component of an entire load of the image data.

13. The method of claim 12, wherein adjusting the predetermined number of sustain pulses is performed by increasing and decreasing the predetermined number of sustain pulses in proportion to (the horizontal component load/vertical component load) of the load.

14. The method of claim 12, wherein the horizontal component load is calculated by the following Equation;
$$H = \frac{{N}_{tot - on}}{{N}_{line - on}}$$
where H denotes the horizontal load component, Nₜₒₜ₋ₒₙ denotes a number of cells that are turned on in each subfield, and Nₗᵢₙₑ₋ₒₙ denotes a number of lines in which turned-on cells exceed more than a predetermined percentage in the lines of the PDP.

15. The method of claim 14, wherein the predetermined percentage is 10%.
